(19) United States
(12) Patent Application Publication
(10) Pub. No.: US 2003/0048194 A1
(43) Pub. Date: Mar. 13, 2003

(54) Indicator device for vehicle using polarizing film layer

(76) Inventor: Toshiki Wada, Kariya-city (JP)

Correspondence Address: LAW OFFICES OF DAVID G. POSZ, 2000 L STREET, N.W., SUITE 200, WASHINGTON, DC, 20036, US

(21) Appl. No.: 10/151,188

(22) Filed: May 21, 2002

(30) Foreign Application Priority Data
Sep. 7, 2001 (JP) 2001-272678

(51) Int. Cl. G08B 5/00

(52) U.S. Cl. 340/815.4; 340/438; 359/601

(57) ABSTRACT

An indicator device for vehicles has an information indicator panel, and a cover provided in front of the panel. The cover comprises a base layer, a polarizing layer, an anti-glare layer and an anti-reflection layer. The cover is arranged so that P-polarized light from the polarizing layer becomes incident to a front windshield in an angle of about 56°. Thus, the reflectance of the P-polarized light is reduced to about zero, and the light emitted from the panel is restricted from forming a virtual image by reflection on the front windshield.

### CROSS REFERENCE TO RELATED APPLICATION

This application is based on and incorporates herein by reference Japanese Patent Application No. 2001-272678 filed on Sep. 7, 2001.

### FIELD OF THE INVENTION

The present invention relates to an indicator device for vehicles that is mounted underneath a front windshield and in front of a driver's seat in a vehicle.

### BACKGROUND OF THE INVENTION

An indicator device is mounted underneath a front windshield and in front of a driver's seat in a vehicle to indicate by its pointer on its panel various information such as vehicle travel speed, engine rotation speed and engine coolant temperature. The indicator device has a transparent cover disposed in front of the panel and the pointer. In the day time, external light incident to the indicator device reflects at the cover and dazzles a driver. In the night time, reflection of the illuminated panel is formed as a virtual image on the front windshield, thereby hindering a driver.

JP-A-10-221122 proposes to provide an anti-reflection film on a transparent cover of an indicator device to reduce the light reflected towards a driver. However, reduction of the reflected light by the transparent cover is limited. It also proposes to provide a light path direction restrictor on the panel and the pointer to shut off light traveling from the panel to the front windshield. The restrictor however hinders visibility of a driver and adds complication of the construction of the device.

### SUMMARY OF THE INVENTION

It is therefore an object of the present invention to provide an indicator device for vehicles which provides improved visibility.

According to one aspect of the present invention, an indicator device for vehicles has an information indicator panel, and a cover provided in front of the panel. The cover comprises a base layer an anti-glare layer and an anti-reflection layer. The combination of the anti-glare layer and the anti-reflection layer reduces reflection of sunlight at the cover so that a driver is not dazzled.

According to another aspect of the present invention, a polarizing layer is provided in front of an information indicator panel. The polarizing layer is arranged so that P-polarized (parallel-polarized) light from the polarizing layer becomes incident to a front windshield in an angle of about 56°, with which the reflectance of the P-polarized light is reduced to about zero. The light emitted from the panel is restricted from forming a virtual image by reflection on the front windshield.

### BRIEF DESCRIPTION OF THE DRAWINGS

The above and other objects, features and advantages of the present invention will become more apparent from the following detailed description made with reference to the accompanying drawings.

FIG. 1 is a sectional view of a combination meter according to an embodiment of the present invention;

FIG. 2 is a front view of the combination meter shown in FIG. 1;

FIG. 3 is a sectional view of a cover used in the combination meter;

FIG. 4 is a graph showing the relation between the angle of incidence and the reflectance of polarized lights;

FIG. 5 is a schematic view showing orientation of the combination meter relative to a windshield and a driver in a vehicle;

FIG. 6 is a sectional view of the cover of the combination meter according to a modification of the embodiment;

FIG. 7 is a sectional view of the combination meter according to another modification of the embodiment;

FIG. 8 is a perspective view showing a modified location of the combination meter; and

FIG. 9 is a perspective view showing another modified location of the combination meter.

### DETAILED DESCRIPTION OF THE PREFERRED EMBODIMENT

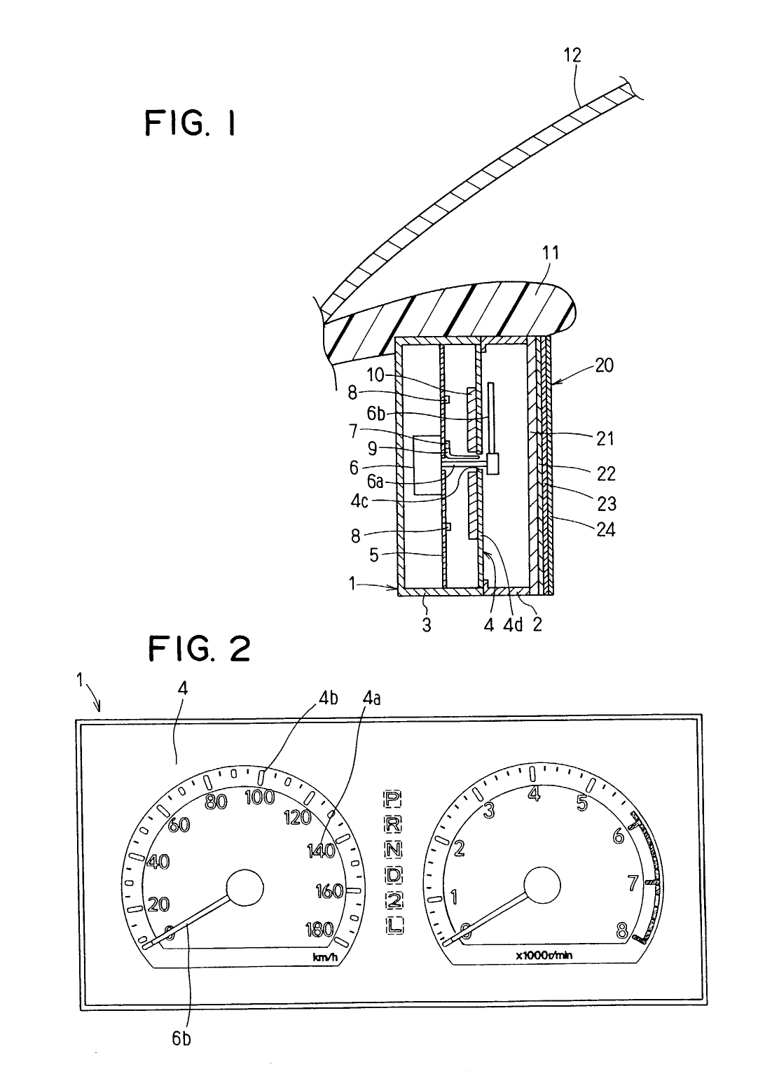

Referring first to FIGS. 1 and 2, a combination meter 1 is provided as an indicator device under a dashboard 11 underneath a front windshield 12 of a vehicle so that it may be viewed from a driver's seat (right side in FIG. 1). The front side of the combination meter 1 is defined as the side, which faces the driver's seat. The combination meter 1 has a panel 4 on which various information are indicated. The panel 4 is made of a transparent polycarbonate panel. Characters 4a and scales 4b are printed or hot-stamped with a semi-transparent colored plate on the front surface 4d of the panel 4. A light conductive plate 10 is fixed to the rear surface of the panel 4 to collect light emitted from a light emitting diode (LED) 8 and conducts the collected light to the panel 4 so that the characters 4a and the scales 4b are illuminated. The conductive plate 10 is made of a transparent resin such as acrylic resin.

The combination meter 1 has a casing 3 at the rear side of the panel 4. In the casing 4, a printed circuit board 5 is provided as a part of electronic circuit unit of the combination meter 1. The LED 8 is mounted on the board 5 together with a movement 6 that rotates a shaft 6a by an angle corresponding to electric signals applied from outside. The shaft 6a passes through a central hole 4c of the panel 4 and connects to a needle pointer 6b. The pointer 6b is made of a transparent or semitransparent acrylic resin or the like and illuminated with light emitted from an LED 7 and conducted through a light conductor 9 made of a transparent resin such as acrylic resin. The LED 7 and the light conductor 9 are also mounted on the board 5.

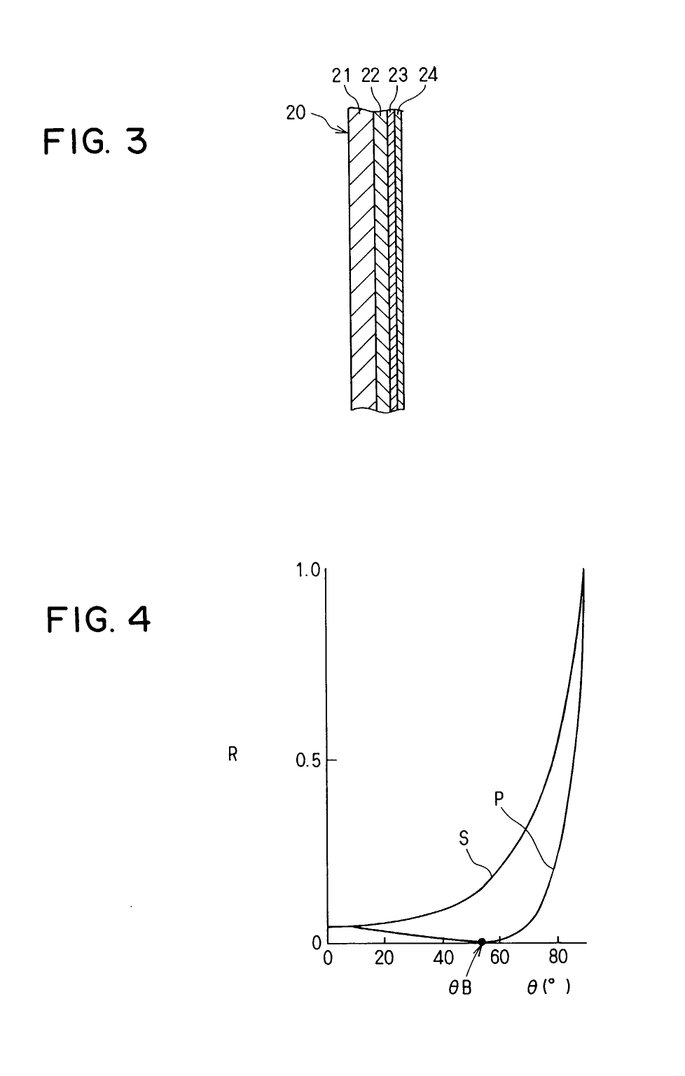

A cover 20 is provided on the front side of the panel 4 and attached to the same through a tubular part 2. As shown in FIG. 3, the cover 20 has a base layer 21 made of a transparent acrylic or polycarbonate resin or a transparent glass, and a polarizing plate 22 attached to the front surface of the base layer 21 by a transparent adhesive. An anti-glare film layer 23 is attached to the front surface of the polarizing plate 22, and an anti-reflection film layer 24 is attached to the front surface of the anti-glare film layer 23. Those plates may be formed by coating or the like.

The polarizing plate 22 is made of a polarizing film having polarizing characteristics and a pair of protective plastic sheets attached to both sides of the polarizing film. Light from light emitting parts, that is, characters 4a, scales 4b and pointer 6b on the panel 4, impinge the polarizing plate 22 through the base layer 21 and are polarized by the polarizing plate 22 so that only light polarized in the specific direction is allowed to pass through the polarizing plate 22. The cover 20, specifically, the polarizing plate 22, is disposed at a position and in an angle that causes the polarized light projected from the polarizing plate 22 enters the front windshield 12 as P-polarized (parallel-polarized) light.

FIG. 4 shows relations between angle of incidence θ and reflectance R of P-polarized light and S-polarized (sheer-polarized) light. The reflectance of P-polarized light becomes zero when the angle of incidence becomes a Brewster angle θB. Brewster angle is defined as an angle that satisfies tanθB=n, where n is refractive index of a reflecting material. Therefore, the reflectance R is made zero by directing the P-polarized light to be incident to a material in Brewster angle of that material. In the case of glass, the Brewster angle is about 56°, because the refractive index is n=1.5.

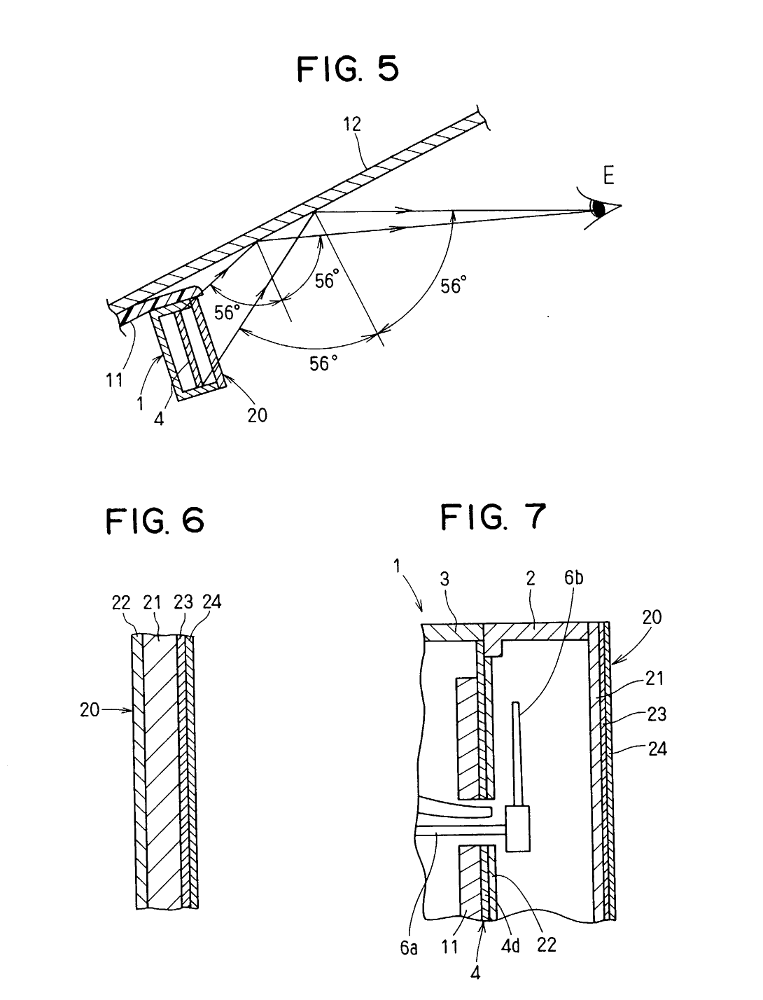

The polarizing plate 22 (cover 20) is arranged relative to the windshield 12 in a vehicle as shown in FIG. 5. Specifically, the indicator device 1 is so arranged that the polarized light projected from the polarizing plate 22 and reflected at the front windshield 12 toward the driver's eyes E becomes incident to the windshield 12 at the angle that is equal to he Brewster angle θB=56°. Thus, the reflectance of the light projected from the panel 4 and incident to the windshield 12 through the polarizing plate 22 is made zero. As a result, the light passing through the polarizing plate 22 and reflected at the windshield 12 toward the driver's side can be made almost zero. That is, formation of the virtual image of the panel on the windshield 12 as a reflection is restricted. Therefore, front visibility of a driver can be ensured.

The anti-glare film layer 23 formed on the surface of the polarizing plate 22 is a hard coating having a great number of fine convexities and concavities. This plate 23 thus diffuse-reflects by the convexities and concavities external light (sunlight, for instance) incident from the driver's side and minimizes reflection of the incoming external light toward a driver.

The anti-reflection film layer 24 formed on the surface of the anti-glare film layer 23 is a multiple of coatings of transparent thin films of inorganic dielectric materials (SiO₂, TiO₂, MgF₂, etc) having different refractive indices. This plate 24 thus cancels out the incoming external light (sunlight) incident from the driver's side by interference at the boundary surfaces of each thin film coating and reduces the amount of light reflected toward the driver's side.

According to this embodiment, in day time, the external light (sunlight, for instance) incident to the cover 20 is reflected by the anti-reflection film layer 24, and the amount of light that passes to the anti-glare film layer 23 and the amount of light that is reflected is also reduced as described above. In addition, the light incident to the anti-glare film layer 23 through the anti-reflection film layer 24 is diffuse-reflected by the convexities and concavities of the anti-glare film layer 23. Thus, the amount of light reflected toward the driver's side is greatly reduced by reflected light amount reducing effects of the two plates 23 and 24.

In night time, on the other hand, the LEDs 7 and 8 are driven to illuminate the characters 4a, scales 4b and pointer 6b. If the cover 20 has only the base layer 21, the light passes the base layer 21 and reflects at the windshield 12. As a result, a virtual image of the reflected light is formed on the windshield 12. This image is very clear in the darkness, and hinders driver's visibility through the windshield. However, the polarizing plate 22 is provided in the cover 20 to direct the light from the panel 4 toward the windshield 12 as the P-polarized light. Thus, cover 20 is so oriented that the P-polarized light is incident to the windshield 12 in an angle of 560. As a result, the amount of light projected from the panel 4 and reflected by the windshield 12 toward the driver's eyes is minimized sufficiently.

In the above embodiment, the angle of incidence of the P-polarized light may be changed to other than 56° because the height of the driver's eyes E varies from driver to driver. If the position of the driver's eyes E is determined based on 99% eye-range ellipse defined by Japan Automobile Industrial Organization, the angle of incidence should be limited to 56°±5°. In this instance, the reflectance of the P-polarized light at the windshield is 0% to 0.3%. Therefore, the polarizing plate 22 effectively minimizes the formation of virtual image due to reflection on the windshield 12 and ensures good front visibility for almost all drivers.

The above embodiment may be modified in various ways.

For instance, the LEDs 7 and 8 may be replaced with other type of light sources, such as bulbs. The pointer 6b may be made of a discharge tube. In place of analog indication by the pointer 6b, a digital indication may be provided by an electroluminescence device, liquid crystal device, vacuum fluorescent display device or the like.

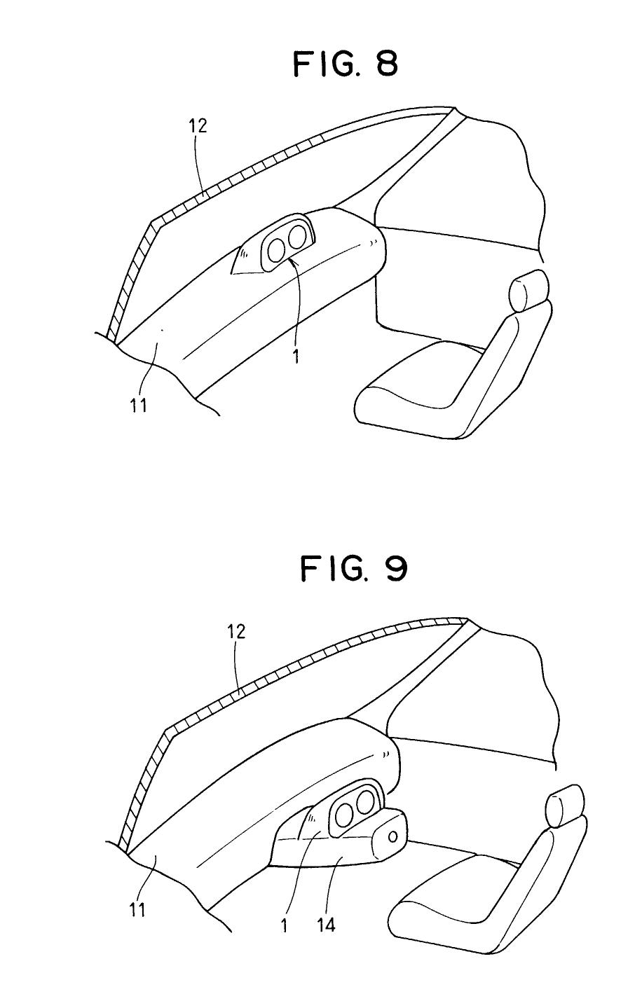

Further, the polarizing plate 22 may be placed at any positions other than between the base layer 21 and the antiglare film layer 23 as long as it is positioned between the indicator panel 4 and the anti-glare film layer 23. For instance, as shown in FIG. 6, the polarizing plate 22 may be attached to the rear side (left side in the figure) of the base layer 21. Alternatively, as shown in FIG. 7, the polarizing plate 22 may be attached to the front surface 4d of the panel 4. The combination meter 1 may be mounted on the dashboard 11 as shown in FIG. 8, or on a steering column 14 as shown in FIG. 9 (no steering is illustrated).

What is claimed is:

1. An indicator device for vehicles comprising:
an indicator panel having an information indicating surface and positioned near a front windshield; and
a cover having a transparent base layer and disposed in front of the indicator panel so that information on the indicator panel is provided through the transparent cover,
wherein the cover further includes an anti-glare film layer formed on the base layer and an anti-reflection film layer formed on the anti-glare film layer.

2. The indicator device as in claim 1, further comprising:
a polarizing film layer disposed between the anti-glare film layer and the indicator panel.

3. The indicator device as in claim 2, wherein the polarizing film layer is disposed between the base layer and the anti-glare film layer, and adhered to the base layer.

4. The indicator device as in claim 2, wherein the polarizing film layer is formed on the information indicating surface of the indicator panel.

5. The indicator device as in claim 2, wherein the polarizing film layer is arranged to project a polarized light as a P-polarized light toward the front windshield so that it becomes incident to the front windshield in an angle of incidence of about 56°.

6. The indicator device as in claim 1, wherein the indicator panel and the cover are mounted on a dashboard or a steering column.

7. An indicator device for vehicles comprising:
an indicator panel having an information indicating surface and positioned near a front windshield; and
a cover having a transparent base layer and disposed in front of the indicator panel so that information on the indicator panel is provided through the transparent cover,
wherein the cover further includes a polarizing film layer arranged to polarize light from the indicator panel and project a polarized light as a P-polarized light toward the front windshield at an angle of incidence which provides a minimum reflectance of the P-polarized light at the front windshield.

8. The indicator device as in claim 7, wherein the angle of incidence of the P-polarized light to the front windshield is about 56°.

9. The indicator device as in claim 7, wherein the cover further includes an anti-glare film layer formed on the base layer, and the polarizing film layer is disposed between the base layer and the anti-glare film layer.

10. The indicator device as in claim 9, wherein the cover further includes an anti-reflection film layer formed on the anti-glare film layer.
